(19) United States
(12) Patent Application Publication
(10) Pub. No.: US 2012/0108879 A1
(43) Pub. Date: May 3, 2012

(54) MICROWAVE DISPOSAL SYSTEM FOR HAZARDOUS SUBSTANCES

(76) Inventors: Chang Yul Cha, Roseville, CA (US); Paul Gil Vergnani, Antelope, CA (US)

(21) Appl. No.: 12/917,438

(22) Filed: Nov. 1, 2010

(51) Int. Cl. A62D 3/178; B01J 19/08

(52) U.S. Cl. 588/310; 422/186

(57) ABSTRACT

A system and method for destruction of energetic compounds, medical wastes and unwanted pharmaceuticals using microwave energy. Waste materials are first mixed into a dilute water solution, slurry or emulsion. The dilute waste flows to a first microwave reactor containing silicon carbide. The silicon carbide absorbs the microwave energy, heats and vaporizes the liquid. The vapor flows to a second microwave reactor containing silicon carbide and an oxidation catalyst. Air is added and the waste portion of the vapor is oxidized to carbon dioxide. Water is recovered in a condenser and recycled. Carbon dioxide and remaining air is vented. Solid organic wastes such as contaminated disposable gloves and towels are gasified in a first microwave reactor with air and oxidized in the second microwave reactor.

### STATEMENT REGARDING FEDERALLY SPONSORED RESEARCH OR DEVELOPMENT

This invention was made with Government support under SBIR Grant No. FA93021-09-M-0003, awarded by the Department of Defense. The Government has certain rights in this invention.

### CROSS-REFERENCE TO RELATED APPLICATIONS

Not Applicable

### INCORPORATION-BY-REFERENCE OF MATERIAL SUBMITTED ON A COMPACT DISC

Not Applicable

### NOTICE OF MATERIAL SUBJECT TO COPYRIGHT PROTECTION

A portion of the material in this patent document is subject to copyright protection under the copyright laws of the United States and of other countries. The owner of the copyright rights has no objection to the facsimile reproduction by anyone of the patent document or the patent disclosure, as it appears in the United States Patent and Trademark Office publicly available file or records, but otherwise reserves all copyright rights whatsoever. The copyright owner does not hereby waive any of its rights to have this patent document maintained in secrecy, including without limitation its rights pursuant to 37 C.F.R. §1.14.

### BACKGROUND OF THE INVENTION

1. Field of the Invention

This invention pertains generally to destruction of small quantities of environmentally hazardous waste and more particularly to destruction of propellants, explosives, and pyrotechnics (PEP) wastes, associated PEP laboratory material wastes, medical wastes and expired and off-specification pharmaceuticals.

2. Description of Related Art

During the normal course of research, development, and testing by the military research laboratories, small quantities of propellants, explosives, and pyrotechnics (PEP) wastes are produced. The PEP waste materials include Nitroaromatics, Nitramines, and Nitrate Esters and are prepared by incorporation of energetic functionalities such as nitro (NO₂), nitrile (CN), or azide (N₃) with heterocyclic ring structures with high heat of formation.

The main problem that need to be addressed is effectively destroying the PEP wastes safely. State and Federal regulatory agencies require permits to store these waste PEP materials in the laboratory under the Resource Conservation and Recovery Act (RCRA). In addition, the off-site disposal of these environmentally hazardous wastes is very expensive and a heavy regulatory burden to the laboratory.

Currently, an open burn/open detonation (OB/OD) process is used to dispose of these energetic materials. The compliance costs and burden associated with OB/OD operations are considerable. These include permit fees, ground water, soil and air sampling, analysis and monitoring of environmental impacts, regulatory tracking and reporting, and compliance inspection. Consequently, the destruction of small quantities of PEP waste materials using the OB/OD process is impractical and not cost-effective.

PEP waste materials also are disposed of by being dissolved in water, followed by the use of Supercritical Water Oxidation (SCWO) to destroy the energetic compounds in the water. The SCWO process has been developed for the oxidation of hydrocarbons or hydrazine in aqueous solutions. However, the high temperature and pressure required to operate the process (1,500° F. and 3,400 psig) create severely corrosive conditions and solid precipitation problems that require SCWO units to use very expensive materials. SCWO is not a viable option to treat small quantities of PEP wastes due to the extreme operating conditions required by the process.

If PEP waste is destroyed safely in small quantities soon after it is produced, without creating any air and water pollutants, the need for the OB/OD process can be eliminated. Additionally, the compliance costs and burden associated with OB/OD operations can be avoided. Currently there are no conventional technologies that can be used to destroy small quantities of energetic waste materials onsite where those are produced.

Hospitals and medical offices in the United States currently generate more than 700 million pounds of infectious medical waste annually. This waste contains both bacterial and viral infections that pose a potential threat to the employees who come into contact with it, as well as, people living near to the areas where this waste is being disposed of or along the route of conveyance. The volume of waste being produced also poses a significant risk to the environment that it is being dumped in. In the past, people dealt with this type of hazard using large incinerators, which produced a poisonous gas, dioxin, as one of its byproducts. In recent years, the EPA has enacted strict regulations on these dioxin emissions and, as a result of these regulations the industry has been forced to abandon incinerators and find new solutions to this rapidly growing problem.

Another disposal method for medical waste is Electro Thermal Deactivation (ETD). ETD uses radio waves to heat the infectious material and kill all biological material contained in it. This technology is combined with shredding which reduces the volume of waste being produced and leaves the product unrecognizable. Current medical destruction technologies such as the incineration and ETD require transport of medical wastes to the central location for treatment. If the medical wastes are destroyed at the point of generation, there will be less chance of an accident during handling and transport that might expose people to the infectious waste being destroyed.

Microwave energy has been shown to destroy bacteria, viruses and organism DNA in air and water at lower temperatures than conventional thermal destruction methods.

Expired and off-specification pharmaceuticals are currently transported from production facilities, hospitals, medical offices, care facilities and pharmacies and disposed of off-site. This off-site disposal of expired medicines is very expensive and transport and handling creates social safety problems. The onsite disposal of expired and off-speciation pharmaceuticals can reduce the economic and regulatory burden to hospitals, pharmacies and the pharmaceutical industry. It can also improve the society safety associated with handling, transport and disposal of expired medicines.

Microwave systems are used for many industrial and chemical processes. In one example, microwaves lower the effective activation energy required for desirable chemical reactions since they can act locally on a microscopic scale by exciting electrons of a group of specific atoms in contrast to normal global heating which raises the bulk temperature. Further this microscopic interaction is favored by polar molecules whose electrons become easily locally excited leading to high chemical activity; however, non-polar molecules adjacent to such polar molecules are also affected but at a reduced extent. An example is the heating of polar water molecules in a common household microwave oven where the container is of non-polar material, that is, microwave-passing, and stays relatively cool.

In this sense microwaves are often referred to as a form of catalysis when applied to chemical reaction rates; thus, in this writing the term “microwave catalysis” refers to “the absorption of microwave energy by carbonaceous materials when a simultaneous chemical reaction is occurring”. For instance, refer to Kirk-Othmer, Encyclopedia of Chemical Technology, 3rd Edition, Volume 15, pages 494-517, Microwave Technology.

What is needed is a system that can dispose of energetic organic compounds, medical wastes and unwanted pharmaceuticals in a safe and reliable manner. The system must be able to operate at low-temperature and pressure with low-concentration PEP wastes to prevent energetic reactions and the creation of harmful secondary pollutants during the waste destruction process. The system should be compact and appropriate for onsite use.

### BRIEF SUMMARY OF THE INVENTION

Embodiments of the present invention include a system and method for destruction of environmental hazardous wastes using microwave energy including energetic compounds, medical wastes and unwanted pharmaceuticals. In one embodiment, waste materials are first mixed into a dilute water solution, slurry or emulsion. The liquid is mixed with air in a first microwave reactor containing silicon carbide. The silicon carbide absorbs the microwave energy and heats and vaporizes the liquid. The vapor and air flows to a second microwave reactor containing silicon carbide and an oxidation catalyst. The waste portion of the vapor is oxidized to carbon dioxide. Water is recovered in a condenser and recycled. Carbon dioxide and remaining air is vented. Solid organic wastes such as contaminated disposable gloves and towels are gasified in a first microwave reactor and oxidized in the second microwave reactor.

In one embodiment, liquid or solid PEP wastes or expired and off-specification pharmaceuticals are mixed with water in a mixer to dissolve in a water solution, or create emulsions with non-aqueous liquid wastes or create slurries with solid wastes. The diluted waste mixture is then pumped through a heat recovery heat exchanger for preheating. The preheated solution is mixed with air and enters the bottom of a microwave evaporation reactor. This reactor is filled with silicon carbide (SiC) granules that absorb microwave energy, transferring heat to the solution. Solid PEP wastes will decompose, and liquid PEP wastes will evaporate. The waste vapors then enter a microwave oxidation unit and are oxidized to carbon dioxide, water vapor, and nitrogen. The exhaust from the oxidation unit flows through the heat recovery heat exchanger prior to entering the refrigerated chiller that cools the exhaust prior to entering the vapor liquid separator. The separator removes the water droplets from the exhaust, sending the water condensate to the recovery tank, and allowing the non-condensable vapors to exit through the exhaust stack. Recycled water is used again in the mixer.

In another embodiment a microwave solid disposal reactor is used to destroy contaminated laboratory wastes. The microwave cavity contains a SiC platform that is loaded with the waste materials through a front hatch, which is locked closed. When microwaves are applied the SiC platform, it is quickly heated and starts to heat solid wastes in contact with its surface inducing gasification. Char produced from the gasification of solids also absorbs microwaves, propagating the reaction. The gasses leaving the SiC reactor pass through a particulate filter to remove ash, and then into the microwave oxidation unit to ensure they are completely oxidized. The gas from the microwave oxidizer is directly vented into the atmosphere.

A further embodiment of the invention is a microwave powered apparatus to destroy organic waste that comprises a first reactor volume configured to receive microwave energy, the first reactor volume having a microwave energy absorbent and further configured to receive organic waste, a second reactor volume fluidly coupled to the first reactor volume and configured to receive microwave energy, where the second reactor volume has a microwave energy absorbent, where the second reactor volume has an oxidation catalyst, a source of oxygen fluidly coupled to the second reactor volume, where organic waste is vaporized in the first reactor volume, and where vaporized organic waste is oxidized in the second reactor volume.

An aspect of the invention is a mixing vessel configured to combine organic waste and liquid, where the mixing vessel is fluidly coupled to the first reactor volume.

Another aspect of the invention is a means for separating gas and liquid, where the means for separating is fluidly coupled to the second reactor volume.

A further aspect is where the means for separating further comprises a condenser, where the condenser is fluidly coupled to the second reactor volume, and a gas/liquid separation container fluidly connected to the condenser.

A yet further aspect of the invention is a source of oxygen fluidly coupled to the first reactor volume, and where the first reactor volume is further configured to receive solid organic waste.

Another aspect is where the microwave absorbent in the first reactor volume is a microwave absorbent structure configured to support solid organic waste.

A further aspect is where the source of oxygen comprises an air supply.

A still further aspect is where the microwave absorbent is silicon carbide.

Another embodiment of the invention is a microwave powered apparatus to destroy organic waste that comprises a mixing vessel configured to combine organic waste and liquid, a first reactor volume fluidly coupled to the mixing vessel and configured to receive microwave energy, where the first reactor volume has a microwave energy absorbent, and the first reactor volume is further configured to receive organic waste and liquid, a second reactor volume fluidly coupled to the first reactor volume and configured to receive microwave energy, where the second reactor volume has a microwave energy absorbent and an oxidation catalyst, a source of oxygen fluidly coupled to the second reactor volume, where organic waste is combined with liquid in the mixing vessel, where organic waste and liquid are vaporized in the first reactor volume in the presence of microwave energy, and where vaporized organic waste is oxidized in the second reactor volume in the presence of microwave energy.

Another aspect is where the microwave absorbent is silicon carbide.

A further aspect comprises a condenser fluidly coupled to the second reactor volume, and a gas/liquid separation container fluidly connected to the condenser.

A still further aspect is where the gas/liquid separation container is fluidly coupled to the mixing vessel.

Another aspect of the invention comprises a solid waste reactor fluidly coupled to the second reactor volume, where the solid waste reactor has a microwave absorbent structure and is configured to receive microwave energy, where the solid waste reactor is further configured to receive solid organic waste, a supply of oxygen fluidly coupled to the solid waste reactor, where solid organic waste and oxygen are combined in the solid waste reactor in the presence of microwave energy, and where organic waste is oxidized in the second reactor volume in the presence of microwave energy.

A further aspect is where the microwave absorbent structure comprises silicon carbide and is configured to support solid organic waste.

A yet further aspect of the invention comprises a waveguide fluidly coupled to the first reactor volume and to the solid waste reactor, and a microwave switch coupled to the waveguide, where microwave energy is directed to the first reactor volume or to the solid waste reactor through the waveguide by the microwave switch.

Another aspect comprises a condenser coupled to the second reactor volume and a gas/liquid separation container fluidly connected to the condenser.

A further embodiment of the invention is a method for destroying organic waste with microwave energy that comprises providing a first reactor volume having a microwave energy absorbent, providing a second reactor volume fluidly coupled to the first microwave reactor, where the second reactor volume has a microwave absorbent and an oxidation catalyst, placing organic waste in the first reactor volume, applying microwave energy to the first reactor volume to vaporize the organic waste, providing oxygen to the second reactor volume, and applying microwave energy to the second reactor volume to oxidize the organic waste.

Another aspect of the invention is where the microwave absorbent is silicon carbide.

A further aspect is providing a mixing vessel fluidly coupled to the first reactor volume where the mixing vessel is configured to mix organic waste with liquid, and mixing organic waste with liquid in the mixing vessel.

A still further aspect of the invention is providing a condenser fluidly coupled to the second reactor volume, providing a gas/liquid separation container fluidly coupled to the condenser, and separating gas and liquid in the gas/liquid separation container.

A yet further aspect is providing a mixing vessel fluidly coupled to the first reactor volume, where the mixing vessel is configured to mix organic waste with liquid, mixing organic waste with liquid in the mixing vessel, and recycling liquid from the gas/liquid separation container to the mixing vessel.

Another aspect is where oxygen is provided by a supply of air.

A further aspect is placing solid organic waste in the first reactor volume, and providing oxygen to the first reactor volume.

A still further aspect is providing a microwave absorbent structure in the first reactor volume, where the microwave absorbent structure comprises silicon carbide.

Further aspects of the invention will be brought out in the following portions of the specification, wherein the detailed description is for the purpose of fully disclosing preferred embodiments of the invention without placing limitations thereon.

### BRIEF DESCRIPTION OF THE SEVERAL VIEWS OF THE DRAWING(S)

The invention will be more fully understood by reference to the following drawings which are for illustrative purposes only:

FIG. 1 is a schematic view of a system and method for destroying organic waste material using microwaves.

FIG. 2 is a schematic view of another embodiment of a system and method for destroying organic waste material using microwaves with a single microwave cavity.

FIG. 3 is a schematic view of a further embodiment of a system and method for destroying organic waste material using microwaves with a separate reactor for solid waste.

### DETAILED DESCRIPTION OF THE INVENTION

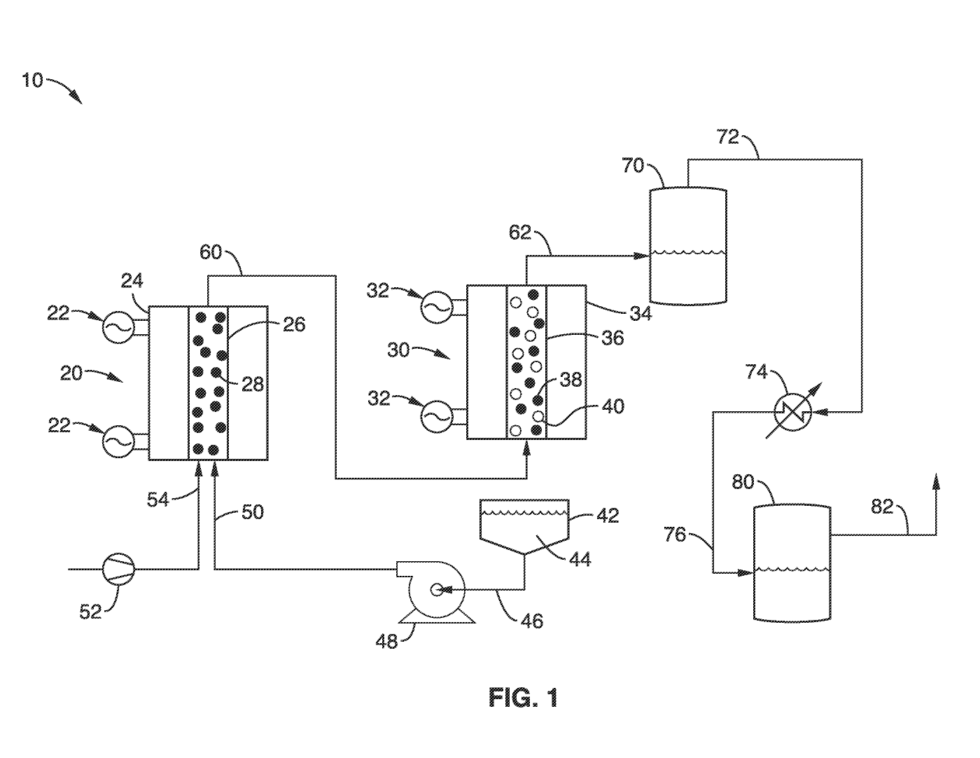

Referring more specifically to the drawings, for illustrative purposes the present invention is embodied in the apparatus generally shown in FIG. 1 through FIG. 3. It will be appreciated that the apparatus may vary as to configuration and as to details of the parts, and that the method may vary as to the specific steps and sequence, without departing from the basic concepts as disclosed herein.

In the context of this patent application, organic waste is not limited to carbon containing compounds. The term “organic waste” includes materials that will react with oxygen (oxidize) or decompose in the presence of an oxidation catalyst or microwave energy, even if these materials or their products of decomposition are traditionally classified as inorganic materials or inorganic compounds.

The terms “vaporized” and “vaporization” as used in this patent application includes pyrolysis, partial pyrolysis and the gasification of solid and liquid organic wastes in the presence of elevated temperatures or microwave energy.

FIG. 1 illustrates the process schematic of a system and method 10 used to prove the concept to destroy propellants, explosives, and pyrotechnics (PEP) wastes. First microwave reactor 20, the vaporization reactor, consists of two 1 kW microwave magnetrons 22 coupled to a microwave cavity 24. First reactor volume 26 is formed with a 3 inch diameter quartz glass cylinder which is transparent to microwaves and is positioned in first microwave cavity 24. First reactor volume 26 contains silicon carbide (SiC) granules 28. Silicon carbide is an excellent microwave energy absorbent. First microwave reactor 20 can be operated with one or both magnetrons 22 energized.

Second microwave reactor 30, the oxidation reactor, also has two 1 kW microwave magnetrons 32 coupled to a second microwave cavity 34 and a second reactor volume 36 formed by a quartz glass cylinder. Second reactor volume 36 is packed with a mix of SiC granules 38 and oxidation catalyst granules 40. In this embodiment, the oxidation catalyst 40 is platinum.

Organic waste mixing vessel 42 contains various dilute solutions 44 of PEP materials. In some cases, the organic waste will not be soluble in water and solution 44 will be in the form of emulsions or slurries. In operation, PEP solution 44 is transported in tube 46 through pump 48 and through tube 50 and into first reactor volume 26. Air pump 52 is connected through tube 54 to first reactor volume 26 to provide oxygen for reaction. The PEP solution 44 is pumped into the bottom of first reactor volume 26 and air is added by air pump 52. Microwave energy applied to first reactor volume 26 vaporizes the PEP solution 44. Some of the higher chain hydrocarbons are also decomposed to lower chain hydrocarbons in first reactor volume 26. The resulting steam and organic gasses are transported through tube 60 to the bottom of second reactor volume 36. The organic PEP chemicals are oxidized to form carbon dioxide in the presence of silicon carbide 38, oxidation catalyst 40 and microwave energy. The mixture of vapor and gases flows out the top of second reactor volume 36 through tube 62 into knockout pot 70 to separate the liquid, vapor and gas components. Remaining vapor and gas flows through tube 72 to condenser 74 to separate condensable liquid. Remaining liquid and gas flows through 76 to separator 80. Exhaust gas 82 is primarily air and carbon dioxide and released to atmosphere. The remaining liquid is primarily water.

PEP solutions tested include 5% monomethylhydrazine, 2% 2-hydroxyethylhydrazine and 5% 2-nitrotoluene. The liquid pump 48 varies the solution flow rate from 0.38 liters per hour (L/hr) to 5.7-L/hr. The air flow rate from air pump 52 varied based on the PEP concentration in the solution and the solution flow rate between 150 and 350 times the stoichiometric reaction rate to form carbon dioxide.

Solution flow rates of 1- to 4-lb/hr were tested and 2- and 3-lb/hr solution flow rates provided the highest chemical destruction efficiencies. There was very little difference in the destruction efficiencies for the solution flow rates of 1- to 4-lb/hr. The destruction efficiencies for all three compounds were measured to be greater than 99.9%.

To test PEP-contaminated solid waste destruction, some modifications were made to the system. The SiC granules 28 were removed from the first reactor volume 26 except one-inch at the bottom. The knockout pot 70, condenser 74 and separator 80 were removed since there is no added water or solutions. Five rubber gloves (33.8 g) and ten paper towels (29.6 g) were cut into small pieces and positioned on the silicon carbide bed within the first reactor volume 26 of evaporation reactor 20.

Air was added to the first reactor volume 26 starting at 10.0 standard cubic feet per hour (scfh), was held there for ten minutes, then increased by 5.0-scfh every four minutes. Air was also added to the bottom of second reactor volume 36 at a flow rate of 2.0 standard cubic feet per minute. The test was completed after 33 minutes. The goal was to gasify the material first in first reactor volume 26 then oxidize the resulting gas in the second reactor volume 36. The second microwave reactor 30 was preheated about half an hour for the test.

The gasification of paper towel and rubber glove pieces started at the bottom and propagated toward the top of first reactor volume 26. Since the pyrolyzed materials absorbed microwave energy, the whole paper and rubber glove mass glowed bright red, confirming that the gasification was occurring over the entire mass. During this test total hydrocarbon concentration of second reactor volume 36 outlet gas started at 209 part per million (ppm), peaked at 261-ppm at three minutes, and decreased to 63-ppm by the completion of the test. The total hydrocarbon concentration of the outlet gas from the first reactor volume 26 was 53,600-ppm, indicating that 99.9% of hydrocarbons produced from first reactor volume 26 was oxidized in the second reactor volume 36.

Ammonium Perchlorate is an oxidizer used with PEP materials and is difficult to destroy. In order to destroy an oxidizer with this system, a reducing environment is used in the reactors. Activated carbon granules are placed in second reactor volume 36 and nitrogen instead of air is introduced into first reactor volume 26. In one test, a 5% Ammonium Perchlorate and water solution was introduced into first reactor volume 26 with nitrogen and resultant vapors flowed into second reactor volume 36. Destruction efficiency using activated carbon in second reactor volume 36 was measured at 99.9%.

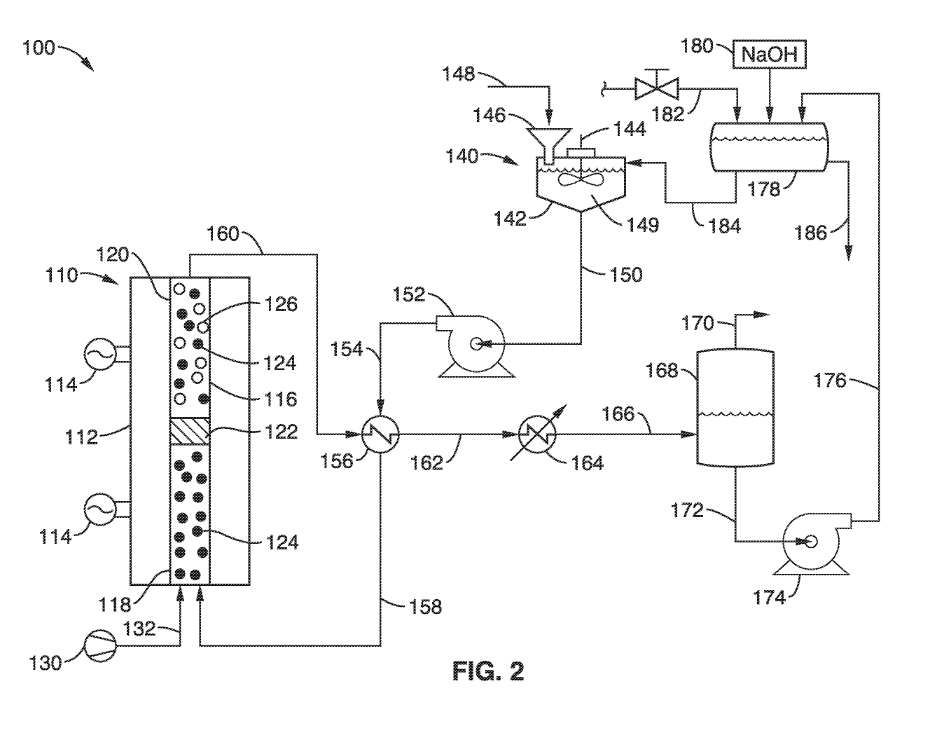

FIG. 2 is a schematic view of another embodiment of a system and method 100 to destroy organic waste including PEP materials, medical waste and expired and off-spec pharmaceuticals that can be placed in a solution, emulsion or slurry. Microwave reactor system 110 consists of a microwave cavity 112 coupled to a plurality of microwave sources 114. A single microwave reactor volume 116 transparent to microwaves is formed inside microwave cavity 112. In the preferred embodiment, microwave reactor volume 116 is formed with a microwave transparent material such as ceramic or a quartz glass tube. Microwave reactor volume 116 is divided into first reactor volume 118 and second reactor volume 120. A porous divider 122 that is transparent to microwave energy such as a porous ceramic or high temperature resistant spun glass is shown as a physical separator between first and second reactor volumes 118, 120. Porous divider 122 can keep the granules in the two reactor volumes separated.

In a further aspect of the invention, divider 122 is omitted and slight mixing of granules occurs between first reactor volume 118 and second reactor volume 120. In a still further aspect, first and second reactor volumes 118, 120 are separate reactor volumes positioned in microwave cavity 120 and fluidly connected with tubing. In another aspect, the microwave cavity 112 is also the microwave reactor volume 116.

First reactor volume 118 contains a microwave energy absorbent 124 such as silicon carbide. Second reactor volume 120 contains a microwave energy absorbent 124 and an oxidation catalyst 126. In one aspect, the oxidation catalyst 126 is platinum, palladium or vanadium. In another aspect of this embodiment, the oxidation catalyst material 126 is coated or plated onto a microwave absorbent material. An oxygen supply 130 such as an air pump or compressor supplies air through tube 132 to first reactor volume 118 as a source of oxygen. In other embodiments, other gas mixtures containing oxygen are supplied through tube 132 to first reactor volume 118.

Organic waste mixing assembly 140 consists of a mixing vessel 142, a means for mixing 144, such as nozzles, a magnetic stirrer or mixing paddles, and a means for adding organic waste 146 to mixing vessel 142 such as a funnel or hopper. Organic waste 148 such as PEP, powder or liquid pharmaceuticals and powder or liquid medical wastes are added to liquid such as water to form dilute solutions, slurries or emulsions 149.

This dilute liquid 149 flows through tube 150, through pump 152 and tube 154 to heat exchanger 156. Warmed liquid continues to flow through tube 158 and into first reactor volume 118. The liquid is vaporized in first reactor volume 118 by the heat provided by microwave energy into microwave absorbent 124. Vapors and gas flow into second reactor volume 120. Vaporized organic waste and oxygen react in the presence of microwave absorbent 124, oxidation catalyst 126 and microwave energy to form carbon dioxide and water. The vapor and gas stream then flows through tube 160 to heat exchanger 156 to transfer heat to liquid in tube 154.

The resultant vapor, gas and liquid in tube 162 flows through condenser 164 to separate condensable liquid. Gas and liquid flow through tube 166 to gas/liquid separation container 168. Remaining gas, primarily carbon dioxide and air, is vented to atmosphere at 170. In a further aspect of this embodiment, a carbon filter is placed on vent 170 to capture any fugitive hydrocarbons. Liquid captured in gas/liquid separation container 168 flows through tube 172, pump 174 and tube 176 to condensate recovery tank 178. A chemical treatment system 180 is coupled to condensate recovery tank 178 to adjust pH. For example, if organic waste molecules contain chlorine, hydrochloric acid will be present in the liquid after microwave destruction. A sodium hydroxide (NaOH) solution can be used to neutralize the hydrochloric acid and form sodium chloride (NaCl). Make up liquid line 182 is also provided to condensate recovery tank 178. Recovered liquid can be recycled to mixing vessel 142 through tube 184. A drain 186 is provided to periodically drain liquid from recovery tank 178 to prevent build up of salts such as sodium chloride.

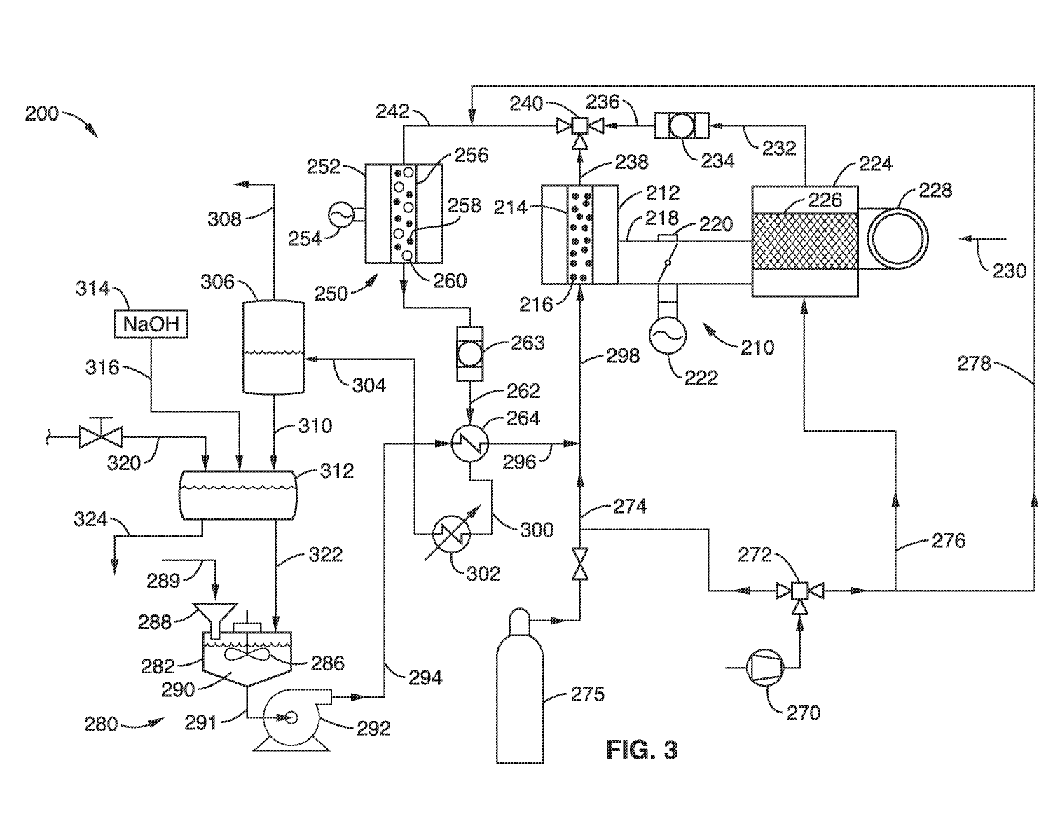

FIG. 3 is a schematic view of another embodiment of a system and method 200 to destroy liquid and solid organic wastes. Microwave vaporizing assembly 210 has a first microwave cavity 212 with a first reactor volume 214 preferably formed by a microwave transparent material such as a ceramic or quartz glass tube. First reactor volume 214 contains microwave absorbent material 216. Material such as silicon carbide, zeolites, and metal compounds will absorb microwave energy.

Microwave waveguide 218 is coupled to first microwave cavity 212 and a microwave switch 220. Microwave switch 220 is coupled to microwave supply 222 and can direct microwave energy in wave guide 218. A solid waste microwave reactor 224 is coupled to waveguide 218 and forms a reactor volume to receive solid waste. A microwave absorbent structure 226, positioned inside microwave cavity 224, is configured to support solid organic wastes. Silicon carbide is an excellent absorbent of microwave energy. In one aspect of the invention, silicon carbide forms a bed or platform structure 226. In another aspect of the invention, microwave absorbent structure 226 is a porous cylinder of silicon carbide that forms a reactor volume to receive solid waste. Solid waste reactor 224 has an access door 228 to allow insertion of solid waste and removal of ash. Solid waste 230 such as nitrile or latex gloves, paper towels, paper masks and miscellaneous disposable items that may be contaminated with PEP or other organic wastes can be placed on microwave absorbent structure 226.

Outlet tube 232 couples to first particulate filter 234. Tube 236 couples the outlet of first particulate filter 234 with outlet tube 238 from first reactor volume 214 through first valve 240. First valve 240 also connects to tube 242 that connects the outlets of microwave vaporizing assembly 210 to microwave oxidizing assembly 250.

Microwave oxidizing assembly 250 has second microwave cavity 252 with a source of microwave energy 254. Second microwave reactor volume 256 is positioned within second microwave cavity 252. Second microwave volume contains microwave absorbent 258 and oxidizing catalyst 260. Outlet tube 262 couples to second reactor volume 256 and has a particulate filter 263 to capture any ash or particles swept through the system. Tube 262 then connects with heat exchanger 264.

An oxygen supply 270 such as an air pump or compressor supplies air to second valve 272. When liquid wastes are processed, air flows through tube 274 toward first reactor volume 214. In one embodiment, inert gas 275, such as nitrogen, is used as a sweep gas through tube 274 to first reactor volume 214.

When solid wastes are processed, second valve 272 directs air to tube 276 which connects to solid waste microwave cavity 224 and to tube 278 which couples to inlet tube 242 into second reactor volume 256.

Organic waste mixing assembly 280 consists of a mixing vessel 282, a means for mixing 286, and a means for adding organic waste 288 to mixing vessel 282 such as a funnel or hopper. Organic waste 289 such as PEP, powder and liquid pharmaceuticals, and powder and liquid medical wastes are added to liquid such as water to form dilute solutions, slurries or emulsions 290.

This dilute liquid flows through tube 291, through pump 292 and tube 294 to heat exchanger 264. Warmed liquid continues to flow through tube 296 and tube 298 into the bottom of first reactor volume 214. The liquid is vaporized in first reactor volume 214 by the heat provided by microwave energy into microwave energy absorbent 216. Vapors and gas flow through first valve 240 and into second reactor volume 256. Vaporized organic waste and oxygen react in the presence of oxidation catalyst 260 and microwave energy to form primarily carbon dioxide and water. The gas and vapor stream then flows through tube 262 and second particulate filter 263 to heat exchanger 264 to transfer heat to liquid in tube 294.

The resultant gas, vapor and liquid from heat exchanger 264 flows in tube 300 through condenser 302 to separate condensable liquid. Condenser 302 uses a source of cooling such as a refrigeration chiller (not shown) to cool condensate to about 5 degrees C. Cooled gas and liquid flow through tube 304 to gas/liquid separation container 306. Remaining gas, primarily carbon dioxide and air, is vented at 308. In a further aspect of this embodiment, a carbon filter (not shown) is placed on vent 308 to capture any fugitive hydrocarbons. Liquid captured in gas/liquid separation container 306 flows through tube 310 to condensate recovery tank 312. A chemical treatment system 314 is coupled to condensate recovery tank 312 by tube 316 to adjust pH. For example, if organic waste molecules contain chlorine, hydrochloric acid will be present in the liquid after microwave destruction. A sodium hydroxide solution can be used to neutralize the hydrochloric acid and form sodium chloride. Make up liquid 320 is also provided to condensate recovery tank 312. Recovered liquid can be recycled to mixing vessel 282 through tube 322. A drain 324 is provided to periodically drain liquid from recovery tank 312 to prevent build up of salts such as sodium chloride.

To destroy organic wastes in solution, the organic waste 289 in liquid or powder form are mixed with water to form a dilute solution, slurry or emulsion 290 in mixing vessel 290. Oxygen supply 270 is directed through valve 272 to first reactor volume 214. Microwave energy is directed to first reactor volume 214 through waveguide 218 by microwave switch 220. The dilute liquid 290 is pumped from organic waste mixing vessel 280 to first reactor volume 214. The liquid is vaporized and flows to second reactor volume 256 where organic waste is oxidized to form carbon dioxide and water. Resultant gas and vapors are cooled in heat exchanger 264 and condensed in condenser 302. Gasses are vented at 308. Liquid is recycled through condensate recovery tank 312.

In another aspect of this method, an inert gas 275, such as nitrogen, is provided as a sweep gas through tube 274 and tube 298 to first reactor volume 214. This reduces potential for energetic oxidation reactions in first reactor volume 214 during vaporization. Vaporized organic waste flows through tube 238 and tube 242 to second reactor volume 256. Oxygen is supplied to second reactor volume 256 through valve 272 and tube 278. Organic waste is oxidized in second reactor volume 256. In this aspect of the system and method, carbon can be used as a microwave adsorbent 216 in first reactor volume 214. Inert gas 275 can also be mixed with oxygen supply 270 to first reactor volume 214 to further control the process.

To destroy solid organic wastes that may be contaminated with PEP or other hazardous substances, the solid organic waste 230 is placed inside the solid waste reactor 224. The door 228 is secured and microwave energy directed at reactor 224 through waveguide 218 by microwave switch 220. A supply of oxygen 270 is directed through second valve 272 to solid waste reactor 224 and second reactor volume 256. The solid waste is vaporized and resultant gas flows through first particulate filter 234 to second reactor volume 256 where the vaporized organic waste is oxidized. Outlet gas flows through tube 262 where the gas is cooled in heat exchanger 264 and condenser 302. The gas is exhausted at vent 308.

If inorganic material or metal objects such as staples or clips are placed on microwave absorbent structure 226, they will remain behind after vaporization and can be removed and disposed of as inert material.

From the description herein it will be appreciated that the present invention can be embodied in various forms, which include but are not limited to the following.

1. A microwave powered apparatus to destroy organic waste, comprising: a first reactor volume configured to receive microwave energy; said first reactor volume having a microwave energy absorbent; said first reactor volume further configured to receive organic waste; a second reactor volume fluidly coupled to said first reactor volume; said second reactor volume configured to receive microwave energy; said second reactor volume having a microwave energy absorbent; said second reactor volume further having an oxidation catalyst; and a source of oxygen fluidly coupled to said second reactor volume; wherein organic waste is vaporized in said first reactor volume; and wherein vaporized organic waste is oxidized in said second reactor volume.

2. An apparatus according to embodiment 1, further comprising a mixing vessel configured to combine organic waste and liquid, said mixing vessel fluidly coupled to said first reactor volume.

3. An apparatus according to embodiment 1, further comprising means for separating gas and liquid, wherein said means for separating is fluidly coupled to said second reactor volume.

4. An apparatus according to embodiment 3, wherein said means for separating further comprises: a condenser, said condenser fluidly coupled to said second reactor volume; and a gas/liquid separation container fluidly connected to said condenser.

5. An apparatus according to embodiment 4, further comprising: a mixing vessel configured to combine organic waste and liquid, said vessel fluidly coupled to said first reactor volume; wherein said gas/liquid separation container is fluidly coupled to said mixing vessel.

6. An apparatus according to embodiment 1, further comprising: a source of oxygen fluidly coupled to said first reactor volume; wherein said first reactor volume is further configured to receive solid organic waste.

7. An apparatus according to embodiment 6, wherein said microwave absorbent in said first reactor volume comprises a microwave absorbent structure configured to support solid organic waste.

8. An apparatus according to embodiment 1, wherein said source of oxygen comprises an air supply.

9. An apparatus according to embodiment 1, wherein said microwave absorbent is silicon carbide.

10. A microwave powered apparatus to destroy organic waste, comprising: a mixing vessel configured to combine organic waste and liquid; a first reactor volume fluidly coupled to said mixing vessel; said first reactor volume configured to receive microwave energy; said first reactor volume having a microwave energy absorbent; said first reactor volume further configured to receive organic waste and liquid; a second reactor volume fluidly coupled to said first reactor volume; said second reactor volume configured to receive microwave energy; said second reactor volume having a microwave energy absorbent; said second reactor volume further having an oxidation catalyst; and a source of oxygen fluidly coupled to said second reactor volume; wherein organic waste is combined with liquid in said mixing vessel; wherein organic waste and liquid are vaporized in said first reactor volume in the presence of microwave energy; and wherein vaporized organic waste is oxidized in said second reactor volume in the presence of microwave energy.

11. An apparatus according to embodiment 10, wherein said microwave absorbent is silicon carbide.

12. An apparatus according to embodiment 10, further comprising: a condenser, said condenser fluidly coupled to said second reactor volume; and a gas/liquid separation container fluidly connected to said condenser.

13. An apparatus according to embodiment 12, wherein said gas/liquid separation container is fluidly coupled to said mixing vessel.

14. An apparatus according to embodiment 10, further comprising; a solid waste reactor fluidly coupled to said second reactor volume; said solid waste reactor having a microwave absorbent structure; said solid waste reactor configured to receive microwave energy; said solid waste reactor further configured to receive solid organic waste; and a source of oxygen fluidly coupled to said solid waste reactor; wherein solid organic waste and oxygen are combined in said solid waste reactor in the presence of microwave energy; and wherein organic waste is oxidized in said second reactor volume in the presence of microwave energy.

15. An apparatus according to embodiment 14, wherein said microwave absorbent structure comprises silicon carbide configured to support solid organic waste.

16. An apparatus according to embodiment 14, further comprising: a waveguide fluidly coupled to said first reactor volume and to said solid waste reactor; and a microwave switch coupled to said waveguide; wherein microwave energy is directed to said first reactor volume or to said solid waste reactor through said waveguide by said microwave switch.

17. An apparatus according to embodiment 14, further comprising: a condenser, said condenser fluidly coupled to said second reactor volume; and a gas/liquid separation container fluidly connected to said condenser.

18. A method for destroying organic waste with microwave energy, comprising: providing a first reactor volume having a microwave energy absorbent; providing a second reactor volume fluidly coupled to said first microwave reactor; wherein said second reactor volume has a microwave absorbent and an oxidation catalyst; placing organic waste in said first reactor volume; providing oxygen to said second reactor volume; applying microwave energy to said first reactor volume to vaporize the organic waste; and applying microwave energy to said second reactor volume to oxidize the organic waste.

19. A method according to embodiment 18, wherein said microwave absorbent is silicon carbide.

20. A method according to embodiment 18, further comprising: providing a mixing vessel fluidly coupled to said first reactor volume; wherein said mixing vessel is configured to mix organic waste with liquid; and mixing organic waste with liquid in said mixing vessel.

21. A method according to embodiment 18, further comprising: providing a condenser fluidly coupled to said second reactor volume; providing a gas/liquid separation container fluidly coupled to said condenser; and separating gas and liquid in said gas/liquid separation container.

22. A method according to embodiment 21, further comprising: providing a mixing vessel fluidly coupled to said first reactor volume; wherein said mixing vessel is configured to mix organic waste with liquid; mixing organic waste with liquid in said mixing vessel; and recycling liquid from said gas/liquid separation container to said mixing vessel.

23. A method according to embodiment 18, wherein oxygen is provided by an air supply.

24. A method according to embodiment 18, further comprising: placing solid organic waste in said first reactor volume; and providing oxygen to said first reactor volume.

25. A method according to embodiment 24, further comprising: providing a microwave absorbent structure in said first reactor volume; wherein said microwave absorbent structure comprises silicon carbide.

Although the description above contains many details, these should not be construed as limiting the scope of the invention but as merely providing illustrations of some of the presently preferred embodiments of this invention. Therefore, it will be appreciated that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.”

What is claimed is:

1. A microwave powered apparatus to destroy organic waste, comprising:
a first reactor volume configured to receive microwave energy;
said first reactor volume having a microwave energy absorbent;
said first reactor volume further configured to receive organic waste;
a second reactor volume fluidly coupled to said first reactor volume;
said second reactor volume configured to receive microwave energy;
said second reactor volume having a microwave energy absorbent;
said second reactor volume further having an oxidation catalyst; and
a source of oxygen fluidly coupled to said second reactor volume;
wherein organic waste is vaporized in said first reactor volume; and
wherein vaporized organic waste is oxidized in said second reactor volume.

2. An apparatus as recited in claim 1, further comprising a mixing vessel configured to combine organic waste and liquid, said mixing vessel fluidly coupled to said first reactor volume.

3. An apparatus as recited in claim 1, further comprising means for separating gas and liquid, wherein said means for separating is fluidly coupled to said second reactor volume.

4. An apparatus as recited in claim 3, wherein said means for separating further comprises:
a condenser, said condenser fluidly coupled to said second reactor volume; and
a gas/liquid separation container fluidly connected to said condenser.

5. An apparatus as recited in claim 4, further comprising:
a mixing vessel configured to combine organic waste and liquid, said vessel fluidly coupled to said first reactor volume;
wherein said gas/liquid separation container is fluidly coupled to said mixing vessel.

6. An apparatus as recited in claim 1, further comprising:
a source of oxygen fluidly coupled to said first reactor volume;
wherein said first reactor volume is further configured to receive solid organic waste.

7. An apparatus as recited in claim 6, wherein said microwave absorbent in said first reactor volume comprises a microwave absorbent structure configured to support solid organic waste.

8. An apparatus as recited in claim 1, wherein said source of oxygen comprises an air supply.

9. An apparatus as recited in claim 1, wherein said microwave absorbent is silicon carbide.

10. A microwave powered apparatus to destroy organic waste, comprising:
a mixing vessel configured to combine organic waste and liquid;
a first reactor volume fluidly coupled to said mixing vessel;
said first reactor volume configured to receive microwave energy;
said first reactor volume having a microwave energy absorbent;
said first reactor volume further configured to receive organic waste and liquid;
a second reactor volume fluidly coupled to said first reactor volume;
said second reactor volume configured to receive microwave energy;
said second reactor volume having a microwave energy absorbent;
said second reactor volume further having an oxidation catalyst; and
a source of oxygen fluidly coupled to said second reactor volume;
wherein organic waste is combined with liquid in said mixing vessel;
wherein organic waste and liquid are vaporized in said first reactor volume in the presence of microwave energy; and
wherein vaporized organic waste is oxidized in said second reactor volume in the presence of microwave energy.

11. An apparatus as recited in claim 10, wherein said microwave absorbent is silicon carbide.

12. An apparatus as recited in claim 10, further comprising:
a condenser, said condenser fluidly coupled to said second reactor volume; and
a gas/liquid separation container fluidly connected to said condenser.

13. An apparatus as recited in claim 12, wherein said gas/liquid separation container is fluidly coupled to said mixing vessel.

14. An apparatus as recited in claim 10, further comprising;
a solid waste reactor fluidly coupled to said second reactor volume;
said solid waste reactor having a microwave absorbent structure;
said solid waste reactor configured to receive microwave energy;
said solid waste reactor further configured to receive solid organic waste; and
a source of oxygen fluidly coupled to said solid waste reactor;
wherein solid organic waste and oxygen are combined in said solid waste reactor in the presence of microwave energy; and
wherein organic waste is oxidized in said second reactor volume in the presence of microwave energy.

15. An apparatus as recited in claim 14, wherein said microwave absorbent structure comprises silicon carbide configured to support solid organic waste.

16. An apparatus as recited in claim 14, further comprising:
a waveguide fluidly coupled to said first reactor volume and to said solid waste reactor; and
a microwave switch coupled to said waveguide;
wherein microwave energy is directed to said first reactor volume or to said solid waste reactor through said waveguide by said microwave switch.

17. An apparatus as recited in claim 14, further comprising:
a condenser, said condenser fluidly coupled to said second reactor volume; and
a gas/liquid separation container fluidly connected to said condenser.

18. A method for destroying organic waste with microwave energy, comprising:
providing a first reactor volume having a microwave energy absorbent;
providing a second reactor volume fluidly coupled to said first microwave reactor;
wherein said second reactor volume has a microwave absorbent and an oxidation catalyst;
placing organic waste in said first reactor volume;
providing oxygen to said second reactor volume;
applying microwave energy to said first reactor volume to vaporize the organic waste; and
applying microwave energy to said second reactor volume to oxidize the organic waste.

19. A method as recited in claim 18, wherein said microwave absorbent is silicon carbide.

20. A method as recited in claim 18, further comprising:
providing a mixing vessel fluidly coupled to said first reactor volume;
wherein said mixing vessel is configured to mix organic waste with liquid; and
mixing organic waste with liquid in said mixing vessel.

21. A method as recited in claim 18, further comprising:
providing a condenser fluidly coupled to said second reactor volume;
providing a gas/liquid separation container fluidly coupled to said condenser; and
separating gas and liquid in said gas/liquid separation container.

22. A method as recited in claim 21, further comprising:
providing a mixing vessel fluidly coupled to said first reactor volume;
wherein said mixing vessel is configured to mix organic waste with liquid;
mixing organic waste with liquid in said mixing vessel; and
recycling liquid from said gas/liquid separation container to said mixing vessel.

23. A method as recited in claim 18, wherein oxygen is provided by an air supply.

24. A method as recited in claim 18, further comprising:
placing solid organic waste in said first reactor volume; and
providing oxygen to said first reactor volume.

25. A method as recited in claim 24, further comprising:
providing a microwave absorbent structure in said first reactor volume;
wherein said microwave absorbent structure comprises silicon carbide.
